(19) United States
(12) Patent Application Publication
(10) Pub. No.: US 2022/0219423 A1
(43) Pub. Date: Jul. 14, 2022

(54) LIGHTWEIGHT STEEL

(71) Applicants: Hathibelagal M. Roshan, (US); Maynard Steel Casting Company, Milwaukee, WI (US)

(72) Inventor: Hathibelagal M Roshan, Fox Point, WI (US)

(73) Assignees: Hathibelagal M. Roshan, Fox Point, WI (US); Maynard Steel Casting Company, Milwaukee, WI (US)

(21) Appl. No.: 17/709,012

(22) Filed: Mar. 30, 2022

Related U.S. Application Data
(63) Continuation-in-part of application No. 16/841,549, filed on Apr. 6, 2020.
(60) Provisional application No. 62/829,236, filed on Apr. 4, 2019.

(51) Int. Cl. B32B 3/14; B32B 15/01; B32B 3/26; C22C 38/44; C22C 38/06; C22C 38/04; C22C 38/02; C22C 38/00

(52) U.S. Cl. CPC B32B 3/14; B32B 15/011; B32B 3/266; C22C 38/44; C22C 38/001; C22C 38/04; C22C 38/02; C22C 38/002; C22C 38/06

(57) ABSTRACT

A lightweight steel slab including a first panel defining a first plane, a second panel spaced apart from the first panel and defining a second plane, and a truss structure coupled to the first panel and the second panel. The truss structure includes a plurality of struts extending between the first panel and the second panel. At least some of the plurality of struts includes linear elements that are obliquely angled relative to the first plane and the second plane.

### CROSS-REFERENCE TO RELATED APPLICATIONS

This application is a continuation-in-part of U.S. patent application Ser. No. 16/841,549, filed Apr. 6, 2020, which claims priority to U.S. Provisional Patent Application No. 62/829,236, filed Apr. 4, 2019, the entire contents of both of which are incorporated herein by reference.

### FIELD OF INVENTION

The present invention relates to lightweight steel and a method for manufacturing lightweight steel.

### BACKGROUND

Metal is considered a foam if pores or voids are distributed within the metal to take up a certain minimum percentage of the total volume of the metal. The introduction of pores or voids into a metal component typically decreases the density and weight of the metal component compared to a solid metal component. Metal foam components also frequently display a higher plate bending stiffness and other desirable mechanical properties than solid metal components. Currently, commercial metal foam components are generally limited to aluminum, despite the fact that steel foam components would exhibit many superior properties if they could be produced in volume at reasonable cost.

Hot rolling is a metal forming process in which a metal is passed through one or more pairs of rolls to reduce the thickness of the metal and make the thickness throughout the metal uniform. The temperature of the metal being rolled is typically above the recrystallization temperature of the metal.

### SUMMARY

Embodiments of the present invention provide the ability to produce lightweight steel plates having consistent densities. In addition, embodiments of the present invention provide the ability to produce steel plates having predictable and enhanced mechanical properties.

Aspects of the present invention provide engineers working with steel a new degree of freedom: density. The design space potentially covered by steel applications can grow significantly with density as a variable. Among other things, the present invention opens new opportunities for designers to find suitable military and naval applications for not only energy absorption, but also blast resistant and ballistic applications to resist the impact of objects due to the high strength and hardness of products produced in accordance with structures and methods presented herein.

In some embodiments, the present invention provides a lightweight steel slab including a first panel defining a first plane, a second panel spaced apart from the first panel and defining a second plane, and a truss structure coupled to the first panel and the second panel. The truss structure includes a plurality of struts extending between the first panel and the second panel. At least some of the plurality of struts includes linear elements that are obliquely angled relative to the first plane and the second plane.

In some embodiments, the present invention provides a lightweight steel slab including a first panel having a first end, a second end, and a length extending between the first end and the second end, a second panel spaced apart from the first panel, and a truss structure integrally formed as a single piece with the first panel and the second panel. The truss structure includes a plurality of struts extending between the first panel and the second panel. The plurality of struts is distributed consistently and repeatedly along the length of the first panel.

In some embodiments, the present invention provides a lightweight steel slab including a first panel, a second panel spaced apart from the first panel, and an auxetic truss structure coupled to the first panel and the second panel. The auxetic truss structure includes a plurality of struts extending between the first panel and the second panel.

### BRIEF DESCRIPTION OF THE DRAWINGS

FIG. 1 is a perspective view of a lightweight steel slab according to an embodiment of the invention.

FIG. 2 is a perspective view of another lightweight steel slab according to an embodiment of the invention.

FIG. 3 is a cross-sectional perspective view of the lightweight steel slab of FIG. 2 taken along section line 3-3.

FIG. 4 is a perspective view of another lightweight steel slab according to an embodiment of the invention.

FIG. 5 is a cross-sectional perspective view of the lightweight steel slab of FIG. 4 taken along section line 5-5.

FIG. 6 is a cross-sectional perspective view of the lightweight steel slab of FIG. 4 taken along section line 6-6.

FIG. 7 is a perspective view of another lightweight steel slab according to an embodiment of the invention.

FIG. 8 is a cross-sectional view of the lightweight steel slab of FIG. 7 taken along the section line 8-8.

FIG. 9 is a perspective view of another lightweight steel slab according to an embodiment of the invention.

FIG. 10 is a cross-sectional view of the lightweight steel slab of FIG. 9 taken along the section line 9-9.

FIG. 11 is a perspective view of another lightweight steel slab according to an embodiment of the invention.

FIG. 12 is a cross-sectional view of the lightweight steel slab of FIG. 11 taken along the section line 12-12.

FIG. 13 is a perspective view of another lightweight steel slab according to an embodiment of the invention.

FIG. 14 is a cross-sectional view of the lightweight steel slab of FIG. 13 taken along the section line 14-14.

FIG. 15 is a perspective view of another lightweight steel slab according to an embodiment of the invention.

FIG. 16 is a cross-sectional view of the lightweight steel slab of FIG. 15 along the section line 16-16.

FIG. 17 is a perspective view of a lightweight steel sheet produced through hot rolling the lightweight steel slab of FIG. 1.

FIG. 18 is a perspective view of a lightweight steel sheet produced through hot rolling the lightweight steel slab of FIG. 2.

FIG. 19 is a perspective view of a lightweight steel sheet produced through hot rolling the lightweight steel slab of FIG. 4.

FIG. 20 is a flow chart depicting a method of producing lightweight steel sheets from lightweight steel slabs through hot rolling.

FIG. 21 is a perspective view of an insert used to form the lightweight steel slabs of FIGS. 2-6 according to an embodiment of the invention.

FIG. 22 is a perspective view of an insert used to form the lightweight steel slabs of FIGS. 7 and 8 according to an embodiment of the invention.

FIG. 23 is a perspective view of an insert used to form the lightweight steel slabs of FIGS. 9 and 10 according to an embodiment of the invention.

FIG. 24 is a perspective view of an insert used to form the lightweight steel slabs of FIGS. 11 and 12 according to an embodiment of the invention.

FIG. 25 is a perspective view of an insert used to form the lightweight steel slabs of FIGS. 13 and 14 according to an embodiment of the invention.

FIG. 26 is a perspective view of an insert used to form the lightweight steel slabs of FIGS. 15 and 16 according to an embodiment of the invention.

### DETAILED DESCRIPTION

Before embodiments of the present invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways.

Some embodiments of steel slabs according to the present invention are described in U.S. Pat. No. 9,623,480 filed Dec. 19, 2014 and U.S. Pat. No. 10,493,522 filed Jun. 2, 2017, both of which are entitled “STEEL FOAM AND METHOD FOR MANUFACTURING STEEL FOAM,” the entire contents of both of which are hereby incorporated by reference. Embodiment of steel slabs according to the present invention have any combination of the chemical component elements set forth below. The component elements presented below can include limitations for the reasons described below, where the unit “%” relating to the chemical component elements in the steel refers to “mass %” unless specified otherwise.

C: 0.1% to 0.35%

Carbon (C) is an element used in steels to achieve surface hardness and strength, which is determined by the percentage of carbon and subsequent heat treatment. Generally, low carbon content steels provide improved toughness. Higher carbon contents provide higher strength, hardness, and hardenability. Carbon in excess of 0.35% contributes to increased brittleness and reduced weldability. Therefore, it is preferably that the carbon content is in the range of 0.10% to 0.35%.

Si: 0.2% to 0.8%

Silicon (Si) has high work hardenability to ensure that ductility is not substantially decreased as the strength is increased, thereby contributing to providing an improved balance between strength and ductility after heat treatment. In addition, silicon is an element typically required to improve material homogeneity by promoting ferrite transformation in the hot rolling stage, and securing a desired grain size and a desired volume fraction. Silicon content of greater than 0.2% produces such an effect. If silicon content exceeds 0.8%, hot-dip galvanizing properties after annealing deteriorate significantly.

Mn: 0.5% to 1.5%

Manganese (Mn) is an element that can contribute to the hardenability of steels, meaning increasing the depth of hardness. In some embodiments, the Mn content is less than 1.5% due to the tendency of Mn to segregate, and the adverse effect of Mn on quench cracking. In quantities greater than 0.5%, Mn can reduce the potential for harmful Type II MnS inclusions in steel. The desired ratio of Mn to Sulfur is 10 to 1. Therefore, the desirable range of Mn is 0.5% to 1.5%

P: less than 0.025%

Phosphorous (P) is an element that can contribute to an increase in the ductile-to-brittle transition temperature, and reduced toughness and ductility in steels. Phosphorous is generally an undesirable element in steels, which preferably is limited to a phosphorous content of less than 0.025%.

S: less than 0.025%

Sulfur (S) in high quantities may form low-melting iron sulfide, a grain boundary phase that causes severe hot shortness during hot rolling if manganese content is not sufficient to counter this effect. Sulfur can also decrease toughness and ductility in steels. Sulfur is generally an undesirable element in steels, which preferably is limited to a sulfur content of less than 0.025%.

Al: 0.01% to 0.08%

Aluminum (Al) is an element often required for deoxidation, which also prevents the formation of gas porosity. Al is also useful in preventing grain growth during heat treatment. In some embodiments, the content of Al is greater than 0.01% to produce such an effect. However, since Al content exceeding 0.08% can lead to the formation of aluminum nitride phase at the grain boundaries and can reduce the toughness and ductility of steel, Al content of 0.08% or less is preferred.

Ni: less than 2.00%

Nickel (Ni) is an element contributing to high strengthening of steel by reducing the ductile-to-brittle transition temperature in steel, and also contributing to high strengthening by increasing quench hardenability during heat treatment. Nickel content of greater than 2.00% can contribute to steels that are prone to the formation of undesirably retained austenite during heat treatment, since nickel is an austenite stabilizer. Therefore, it is preferred that the content of Nickel is less than 2.00%.

Cr: less than 1.5%

Chromium (Cr) is an element contributing to high strengthening of steel by improving hardenability during heat treatment. If Cr content exceeds 1.5%, quench cracking in low alloy steels typically increases. Cr is ordinarily used with other alloying elements, such as Molybdenum. Thus, Cr content of less than 1.5% is preferred.

Mo: less than 0.5%

Molybdenum (Mo) is an element contributing to high strengthening of steel by increasing quench hardenability, and is typically present in high strength low alloy steels. Mo typically reduces the temper embrittlement in steels, and improves the toughness of low alloy steels. If Mo content exceeds 0.5%, no improvement in the effect is recognized in some embodiments. Thus, Mo content of less than 0.5% is preferred.

In the chemical compositions as explained above, the balance of the steel disclosed herein is iron (Fe), and can also include incidental impurities.

The incidental impurities can include, for instance, Sb, Sn, Zn, and Co, and their permissible ranges can be Sb: 0.01% or less; Sn: 0.1% or less; Zn: 0.01% or less; and Co: 0.1% or less. In addition, Ti and Zr may be contained within ranges of ordinary steel compositions, to the extent that the desired effects are not lost. In further embodiments, steel slabs according to the present invention may include chemical compositions that differ from the chemical compositions detailed above. For example, the chemical composition may be that of high alloy steels such as stainless steels, or the like.

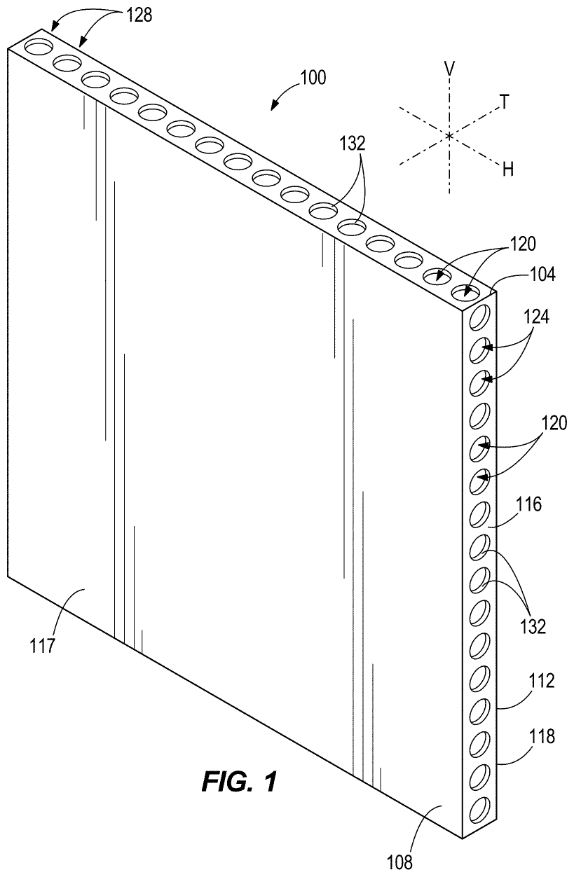

FIG. 1 illustrates a steel slab 100 according to an embodiment of the present invention, prior to a hot rolling cycle. The illustrated steel slab 100 includes a body 104 in the shape of a rectangular prism. The body 104 includes a first face 108 that is generally square in shape, a second face 112 that is generally square in shape and located opposite the first face, and a peripheral edge 116 extending between the first face 108 and the second face 112. The first face 108 and the second face 112 each define an outside face of a first panel 117. In other embodiments, the body 104 may be other desired shapes, and the first face 108 and the second face 112 may likewise have different shapes. As shown, the peripheral edge 116 is four-sided, although the peripheral edge 116 can have fewer or more sides in other embodiments. A distance between the first face 108 and the second face 112 represents a thickness of the peripheral edge 116, which in some embodiments is the smallest dimension of the body 104 in comparison to larger length and width dimensions. In some embodiments, the thickness is greater than 1 inch. In other embodiments, the thickness is less than 2 inches. In the illustrated embodiment, the thickness is within a range of 1 inch to 2 inches. In further embodiments, the thickness may be less than 1 inch or greater than 2 inches.

With continued reference to the illustrated embodiment of FIG. 1, the body 104 also includes a plurality of interconnected pores 120. In the illustrated embodiment, the interconnected pores 120 form a substantially uniform pattern within the steel slab 100. The substantially uniform pattern can be a generally two-dimensional pattern (a grid, array, or lattice, by way of example only) that can define a rectangular pattern within the body 104. In other embodiments, the substantially uniform pattern can be a three-dimensional pattern that can also define a rectangular or prismatic pattern within the body 104. In other embodiments, the two-dimensional or three-dimensional arrangement of pores 120 do not define an identifiable pattern as just described, yet still define a network of interconnected pores 120 within the body 104. The pores 120 are empty voids in the steel slab 100, with each of the plurality of pores 120 connected to at least one other of the plurality of pores 120. In some embodiments, the pores 120 are spherical in shape, and are connected together by cylindrically-shaped voids. In other embodiments, the pores 120 may have any other desired or suitable shape, such cubes, pyramids, or other prisms, cones, tetrahedrons, octahedrons, dodecahedrons, icosahedrons, ellipsoids, tori, ovular shapes, irregular faceted and non-faceted shapes, and the like.

Although in some embodiments (such as in the illustrated embodiment of FIG. 1) the pores 120 have the same shape, in other embodiments two or more pore shapes exist within the body 104. In such embodiments, pores 120 having different shapes can be interconnected as described above, or different unconnected networks of pores can each have a common pore shape that differs from pore network to pore network. Similarly, although in some embodiments (such as the illustrated embodiment of FIG. 1) the pores have the same size, in other embodiments two or more pore sizes exist within the body 104. In such embodiments, pores 120 having different sizes can be interconnected as described above, or different unconnected networks of pores can each have a common pore size that differs from pore network to pore network.

The pores 120 in the illustrated embodiment are arranged in a series of pore rows 124 and pore columns 128, with the pore rows 124 being parallel to a horizontal axis H, and the pore columns 128 being parallel to a vertical axis V. As used herein, terms of orientation such as “horizontal” and “vertical” are for ease of description only, and are not intended to be limiting absent specific reference to the same in the appended claims. As also shown in the embodiment of FIG. 1, pores 120 of the body 104 communicate through the peripheral edge 132 of the lightweight steel component 100. Any number of pores 120 can be open to any one or more of the first and second faces 108, 112, the peripheral edge 116, and/or other exterior surfaces of the body 104 in other embodiments.

In the illustrated embodiment, the plurality of pores 120 forms at least 20% of a total volume of the steel body 104. In some embodiments, the pores 120 may form 20% of the total volume. In other embodiments, the pores 120 may form at least 50% of a total volume of the steel body 104. In other embodiments, the pores 120 may form between 20% and 50% of the total volume. In further embodiments, the pores 120 may form less than 50% of the total volume. In still other embodiments, the pores 120 may form 25%, 30%, 35%, 40%, or 45% of the total volume of the steel body 104. In some embodiments, the calculation of volume (in which the plurality of pores 120 occupies) is made by identifying the bounds of the volume in the body 104 in which the pores 120 exist, and then calculating the space occupied within that volume. Such a calculation can be made, for example, in products in which only a portion of the body 104 has pores 120.

As just described, in some embodiments the plurality of interconnected pores 120 does not extend through an entirety of the steel body 104, such that at least a portion of the steel body 104 is solid. For example, one or more sections of the steel body 104 may include pores to decrease the density of that section(s), while one or more other sections of the steel body 104 may not include pores 120, and may be entirely or relatively solid. By way of example only, the one or more sections with pores 120 may be located in a center of the steel body 104, near one or more edges of the steel body 104, or both. In these and other embodiments, the pores 120 may create a gradient density within the steel body 104 such that the density of pores 120 is different in different locations in the body 104.

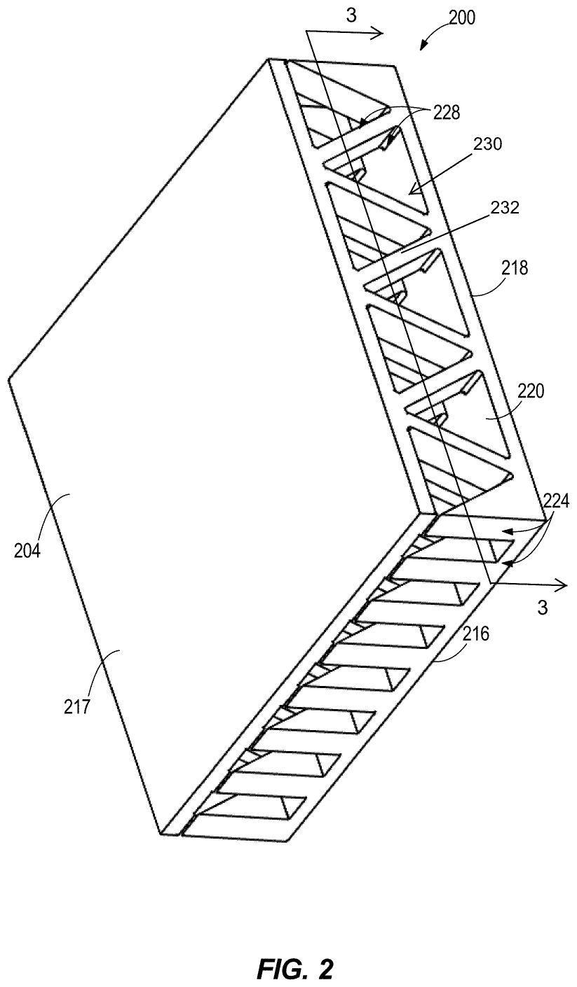

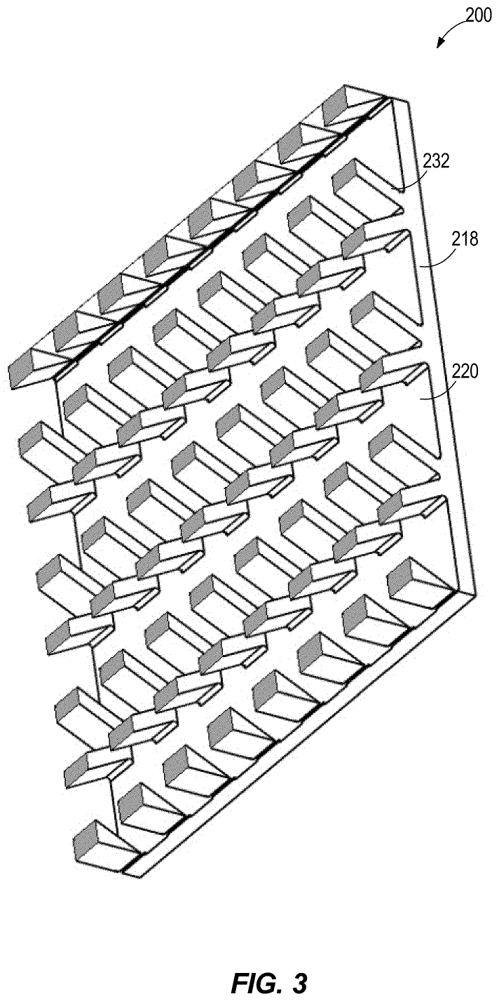

FIGS. 2 and 3 illustrate a steel slab 200 prior to the hot rolling cycle according to another embodiment of the present invention. The steel slab 200 includes a body 204 having pores 220 arranged in a series of pore rows 224 and pore columns 228, similar to the steel slab 100 of FIG. 1. The pores 220 of FIGS. 2 and 3, however, are empty voids shaped as triangular prisms. The triangular prism voids in the illustrated embodiment are disposed at alternating pore rows 224. In other words, the triangular prism voids are disposed at every other pore row 224. At the pore rows 224 that include the triangular prism voids, the triangular prism voids are equally spaced along the pore row 224 such that every pore column 228 includes the triangular prism voids. At the pore rows 224 that do not include triangular prism voids, a rectangular prism void is formed. The rectangular prism voids extend from one peripheral edge 216, to an opposite peripheral edge 216 of the body 204 such that the pore row 224 forms a continuous void. The rectangular prism voids allow communication between triangular prism voids at different pore rows 224 along the pore columns 228. In other words, the rectangular prism voids interconnect the triangular prism voids to form the interconnected pores 220.

With continued reference to the illustrated embodiment of FIGS. 2 and 3, the illustrated pores 220 form a truss structure or strut structure 230 between a first panel 217 and a second panel 218 of the steel slab 200. The strut structure 230 is defined by a plurality of struts 232 extending between the first panel 217 and the second panel 218. Each strut 232 in the illustrated embodiment is a linear element, although in other embodiments some or all of the struts 232 can have other shapes connecting the first and second panels 217, 218, such as curved, stepped, and/or tapered struts. Each strut 232 in the illustrated embodiment is also obliquely angled relative to planes defined by the first panel 217 and the second panel 218. Also in the illustrated embodiment, each strut 232 is angled to a similar degree. For example, each strut 232 may be angled approximately 60 degrees relative to the planes defined by the first panel 217 and the second panel 218. Each strut 232 may alternatively be angled at different degrees, such as 45 degrees, 30 degrees, and the like. In other embodiments, the struts 232 may be oriented at still other angles relative to each other, and/or can each be oriented with respect to the first and second panels 217, 218 at different respective oblique angles. The illustrated struts form truss-like structure between the first panel 217 and the second panel 218.

The first panel 217 and second panel 218 of the illustrated embodiment are flat panels. The panels 217, 218 may also be referred to as skins. Each panel 217, 218 is generally rectangular and planar. In the illustrated embodiment, the first panel 217 and the second panel 218 have similar thicknesses. In other embodiments, the panels 217, 218 may have unequal thicknesses. Additionally or alternatively, the first and second panels 217, 218 may have other (e.g., non-planar and/or non-rectangular) shapes, such as circular, oblong, and the like, or any of the other shapes described above in connection with the body 104 illustrated in FIG. 1. Further, panels 217, 218 may have thicknesses that vary over a length and/or width of the steel slab 200.

Together, the first panel 217, the second panel 218, and the strut structure 230 of the illustrated embodiment form a composite panel. The composite panel may also be referred to as a sandwich panel. In some embodiments, the first panel 217, the second panel 218, and the strut structure 230 may be integrally formed as a single unit. For example, the steel slab 200 may be formed using any of the methods described in U.S. Pat. Nos. 9,623,480 and 10,493,522. In other embodiments, the first panel 217, the second panel 218, and the strut structure 230 may be formed as separate pieces that are secured together in any suitable manner, such as by welding. In such embodiments, at least the strut structure 230 may still be formed using any of the methods described in U.S. Pat. No. 9,623,480. In some embodiments, the strut structure 230 may be integrally formed with only one of the panels 217, 218, and the other panel 217, 218 may be secured (e.g., welded) to the strut structure 230.

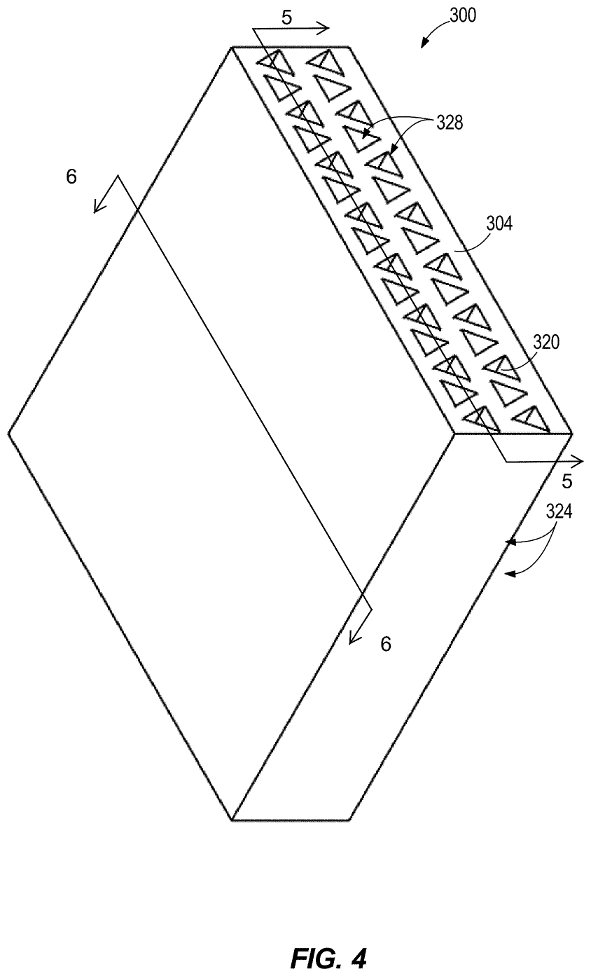

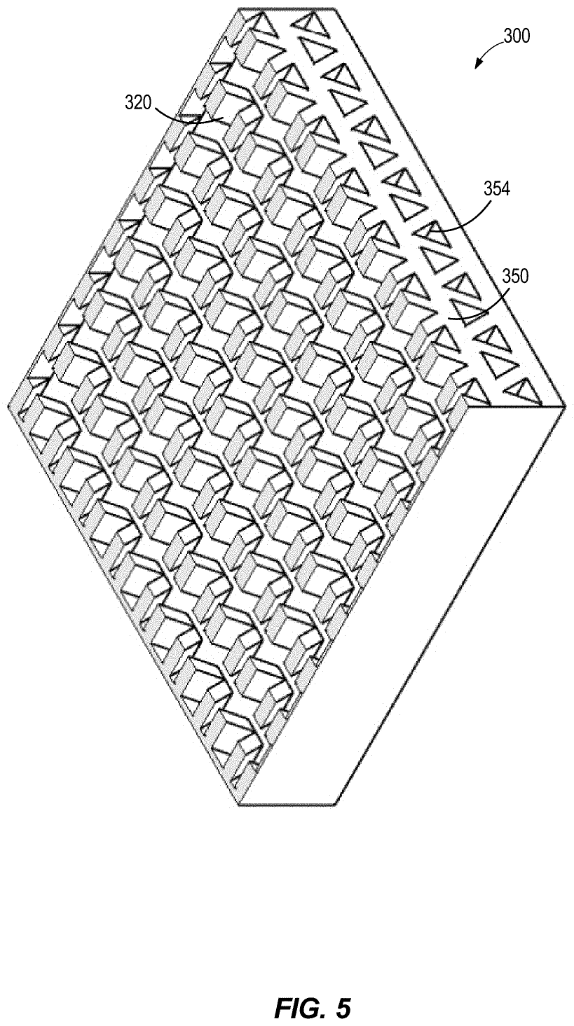

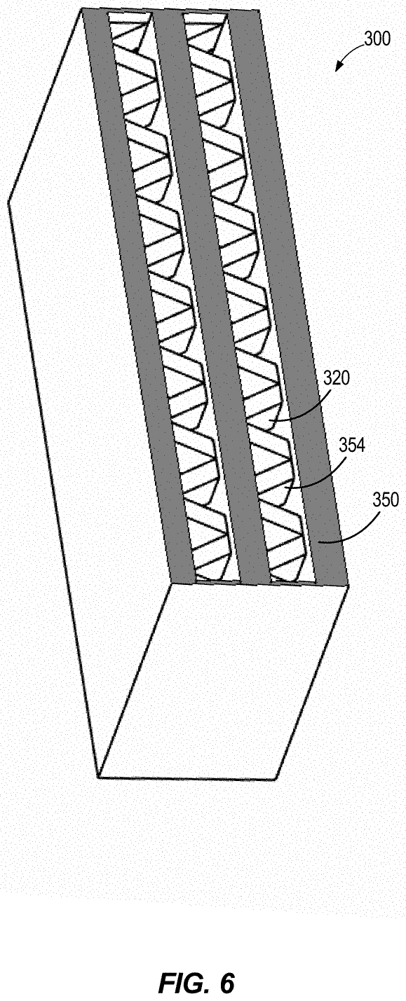

FIGS. 4-6 illustrate a steel slab 300 prior to the hot rolling cycle according to another embodiment of the present invention. The illustrated steel slab 300 includes a body 304 having pores 320 that are empty voids shaped as triangular prisms. In the illustrated embodiment, the pores 320 are arranged in a series of pore rows 324 and pore columns 328 forming triangular prism voids and rectangular prism voids, similar to the pores 220 in the embodiment of FIGS. 2 and 3. Additionally, however, the pores 320 in the illustrated embodiment of FIGS. 5 and 6 are arranged in multiple layers. The illustrated layers are arranged along a thickness of the body 304 of the steel slab 300. The layers alternate between a panel layer 350 and a void layer 354. The panel layer 350 defines a solid rectangular prism, similar to the first and second panels 217, 218 of FIG. 2. The illustrated steel slab 300 includes three panel layers 350 and two void layers 354 such that the void layers 354 are sandwiched between adjacent panel layers 350. In additional embodiments, the steel slab 300 may include alternate numbers of the panel layers 350 and void layers 354 in any desired arrangement (e.g., two void layers 354 immediately adjacent one another, any number of additional alternative panel and void layers 350, 354, and the like).

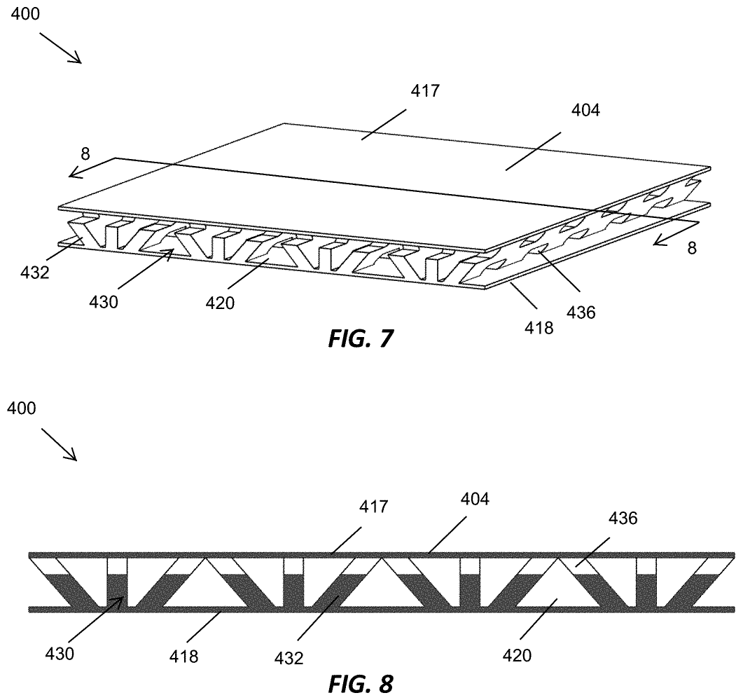

FIGS. 7 and 8 illustrate a steel slab 400 according to another embodiment of the present invention. The steel slab 400 includes a body 404 having pores 420 which form a truss structure or strut structure 430 between a first panel 417 and a second panel 418, similar to the steel slab 200 of FIG. 2. The truss structure 430 is coupled to the first panel 417 and the second panel 418. However, each strut 432 in the illustrated embodiment is either at an oblique angle relative to a plane created by the first panel 417 and the second panel 418 or is angled 90 degrees (i.e., perpendicular) relative to the plane. The struts 432 alternate between being at an oblique angle and being at 90 degrees relative to the plane. The struts 432 are distributed consistently and repeatedly along a length of the first panel 417 such that the truss structure 430 is uniform throughout the steel slab 400. In other words, the struts 732 are arranged in a consistent pattern. In other embodiments, the truss structure 430 may be irregular throughout the steel slab 400. Each strut 432 in the illustrated embodiment is a linear element, although in other embodiments some or all of the struts 432 can have other shapes connecting the first and second panels 417, 418, such as curved, stepped, and/or tapered struts. Each strut 432 extends a length of the steel slab 400 (i.e., from a first end of the first and second panels 417, 418 to a second end of the first and second panels 417, 418). In some embodiments, the struts 432 may only extend a portion of the length of the steel slab 400. In such embodiments, the other portion of the steel slab 400 may be solid or have a different strut.

The illustrated struts 432 form a non-auxetic structure between the first panel 417 and the second panel 418. The non-auxetic truss structure 430 provides ballistic resistance. For example, a bullet or other projectile passing through the steel slab 400 generally passes through at least three “layers” of steel (e.g., the first panel 417, the second panel 418, and one of the struts 432), regardless of the angle of the bullet or other projectile. The non-auxetic truss structure 430 also reduces the weight of the steel slab 430. For example, the illustrated steel slab 430 can weigh about 30% of a similar size, but solid steel slab. Each panel 417, 418 may have a thickness of at least 0.25 inches. In other embodiments, each panel 417, 418 may have a thickness of 0.5 inches or less. In the illustrated embodiment, each panel 417, 418 may have a thickness of about 0.35 inches. In some embodiments, the panels 417, 418 may have different thicknesses relative to each other. The steel slab 400 may have an overall thickness of at least 1 inch. In some embodiments, the steel slab 400 may have an overall thickness of at least 3 inches. In other embodiments, the steel slab 400 may have an overall thickness between 1 and 3 inches.

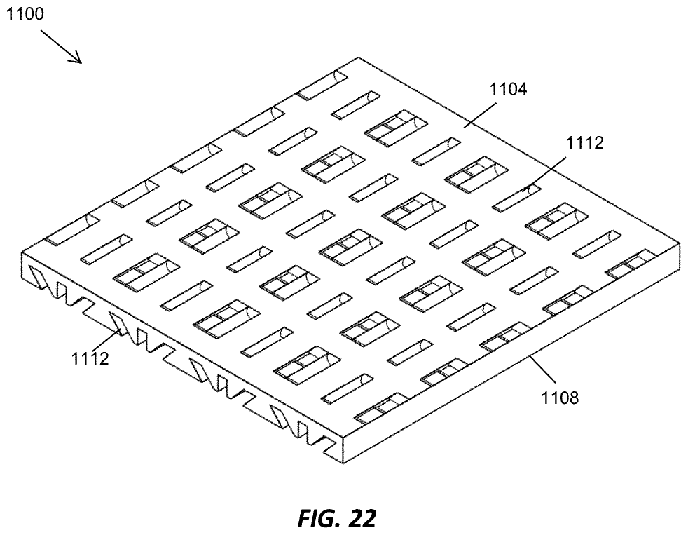

The struts 432 additionally include voids 436. The illustrated voids 436 are positioned at evenly spaced rows and columns along the struts 432 such that the voids 436 are uniform throughout the steel slab 400. The voids 436 allow material from, for example, a 3D printed insert (e.g., insert 1100 in FIG. 22) to be interconnected during casting. The voids 436 may also help fragment and/or deflect a bullet or other projectile passing through the steel slab 400. In the depicted embodiment, the voids 436 are oval in shape. In other embodiments, the voids 436 may have other shapes (e.g., circular, square, hexagonal, etc.). In still other embodiments, the voids 436 may not be present on every or any of the struts 432.

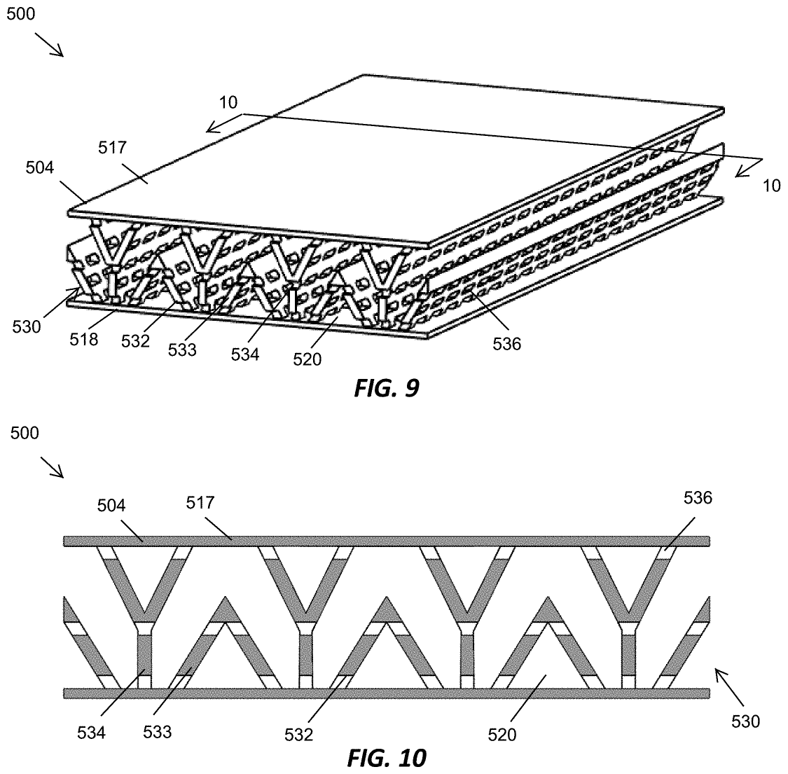

FIGS. 9 and 10 illustrate a steel slab 500 according to another embodiment of the present invention. The steel slab 500 includes a body 504 having pores 520 which form a truss structure or strut structure 530 between a first panel 517 and a second panel 518, similar to the steel slab 200 of FIG. 2. The truss structure 530 is coupled to the first panel 517 and the second panel 518. However, each strut 532 in the illustrated embodiment is V shaped or Y shaped. In other words, the struts 532 include cross-sectional shapes that are V or Y shaped, as shown in FIG. 10. The struts 532 are arranged such that the struts 532 alternate between a V shaped strut 533 and a Y shaped strut 534. The pores 520 are formed between subsequent struts 532. The V shaped strut 533 is attached to solely the second panel 518 such that top points of the V shaped strut 533 are spaced from the first panel 517. The Y shaped strut 534 is attached to the first panel 517 at top points of the Y and the second panel 518 at a bottom point of the Y. In other words, the V shaped strut 533 is upside down relative to the Y shaped strut 534. The struts 532 are distributed consistently and repeatedly along a length of the first panel 517 such that the truss structure 530 is uniform throughout the steel slab 500. In other words, the struts 532 are arranged in a consistent pattern. In other embodiments the truss structure 530 may be irregular throughout the steel slab 500. Each strut 532, 533 extends a length of the steel slab 500 (i.e., from a first end of the first and second panels 517, 518 to a second end of the first and second panels 517, 518). In some embodiments, the struts 532, 533 may only extend a portion of the length of the steel slab 500. In such embodiments, the other portion of the steel slab 500 may be solid or have different struts.

Similar to the struts 432 (FIGS. 7 and 8), the illustrated struts 532 form a non-auxetic structure between the first panel 517 and the second panel 518. As such, the non-auxetic truss structure 530 provides ballistic resistance and reduces a weight of the steel slab 500 by about 70%. Each panel 517, 518 may have a thickness of at least 0.25 inches. In other embodiments, each panel 517, 518 may have a thickness of 0.5 inches or less. In the illustrated embodiment, each panel 517, 518 may have a thickness of about 0.35 inches. In some embodiments, the panels 517, 518 may have different thicknesses relative to each other. The steel slab 500 may have an overall thickness of at least 1 inch. In some embodiments, the steel slab 500 may have an overall thickness of at least 3 inches. In some embodiments, the steel slab 500 may have an overall thickness of at least 6 inches. In other embodiments, the steel slab 500 may have an overall thickness between 1 and 6 inches. In still other embodiments, the steel slab 500 may have an overall thickness between 3 and 6 inches.

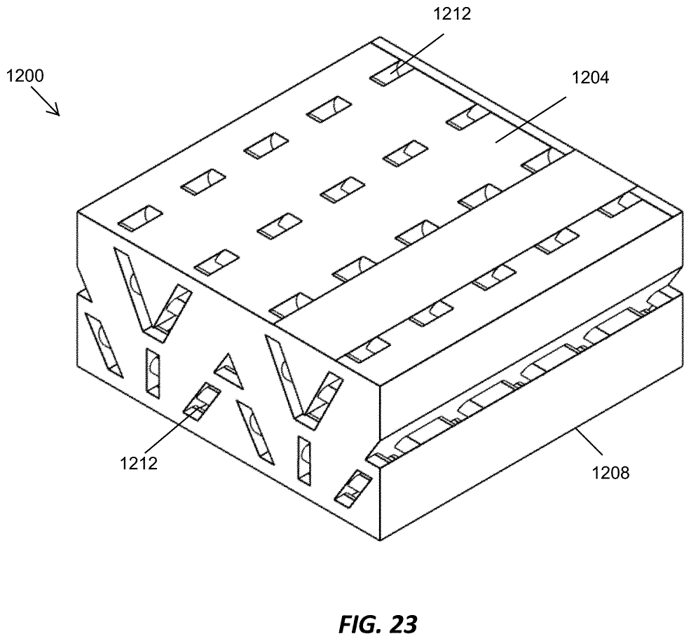

The struts 532 additionally include voids 536. The illustrated voids 536 are positioned at evenly spaced rows and columns along the struts 532 such that the voids 536 are uniform throughout the steel slab 500. The voids 536 allow material from, for example, a 3D printed insert (e.g., insert 1200 in FIG. 23) to be interconnected during casting. In the depicted embodiment, the voids 536 are oval in shape. In other embodiments, the voids 536 may have other shapes (e.g., circular, square, hexagonal, etc.). In still other embodiments, the voids 536 may not be present on every or any of the struts 432.

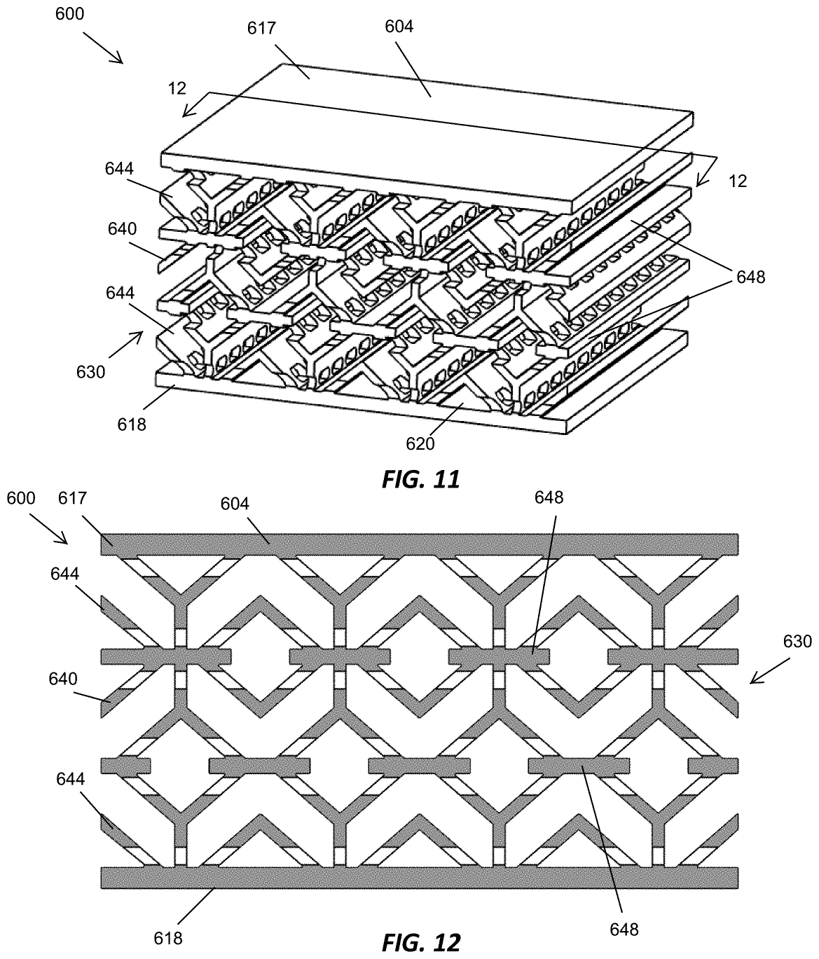

FIGS. 11 and 12 illustrate a steel slab 600 according to another embodiment of the present invention. The steel slab 600 includes a body 604 having pores 620 which form a truss structure or strut structure 630 between a first panel 617 and a second panel 618, similar to the steel slab 200 of FIG. 2. The strut structure 630 is coupled to the first panel 617 and the second panel 618. Each strut 632 in the illustrated embodiment is V shaped or Y shaped. Additionally, the struts 632 in the illustrated embodiment of FIGS. 9 and 10 are arranged in multiple layers. The illustrated layers are arranged along a thickness of the body 604 of the steel slab 600. Each layer 640, 644 is similar to the truss structure 530 (FIGS. 9 and 10) described above. The layers alternate between a first strut layer 640 and a second strut layer 644. The first strut layer 640 is similar to the second strut layer 644, however, the second strut layer 644 is inverted (e.g., rotated 180 degrees) relative to the first strut layer 640. The illustrated steel slab 600 includes two of the second strut layers 644 and one of the first strut layers 640. Each strut layer 640, 644 is interconnected by one or more horizontal struts 648. The horizontal struts 648 are parallel to the first panel 617 and the second panel 618, but each only extends a portion of a width of the steel slab 600. In additional embodiments, the steel slab 600 may include alternate numbers of the first strut layers 640 and the second strut layers 644.

Similar to the struts 432 (FIGS. 7 and 8), the illustrated struts 632 form a non-auxetic structure between the first panel 617 and the second panel 618. As such, the non-auxetic truss structure 630 provides ballistic resistance and reduces a weight of the steel slab 600 by about 70%. The multiple strut layers 640, 644 also provide additional layers for a bullet or other projectile to pass through. Each panel 617, 618 may have a thickness of at least 0.25 inches. In other embodiments, each panel 617, 618 may have a thickness of 0.5 inches or less. In the illustrated embodiment, each panel 617, 618 may have a thickness of about 0.35 inches. In some embodiments, the panels 617, 618 may have different thicknesses relative to each other. The steel slab 600 may have an overall thickness of at least 1 inch. In some embodiments, the steel slab 600 may have an overall thickness of at least 3 inches. In some embodiments, the steel slab 600 may have an overall thickness of at least 6 inches. In other embodiments, the steel slab 600 may have an overall thickness between 1 and 6 inches. In still other embodiments, the steel slab 600 may have an overall thickness between 3 and 6 inches.

The truss structures 430, 530, 630 of the steel slabs 400, 500, 600 shown in FIG. 7-12 are integrally formed with the first panels 417, 517, 617 and the second panels 418, 518, 618. In other embodiments, the truss structures 430, 530, 630 may be formed as separate pieces from one or both of the panels 417, 418, 517, 518, 617, 618 and then secured (e.g., welded) to the panels 417, 418, 517, 518, 617, 618.

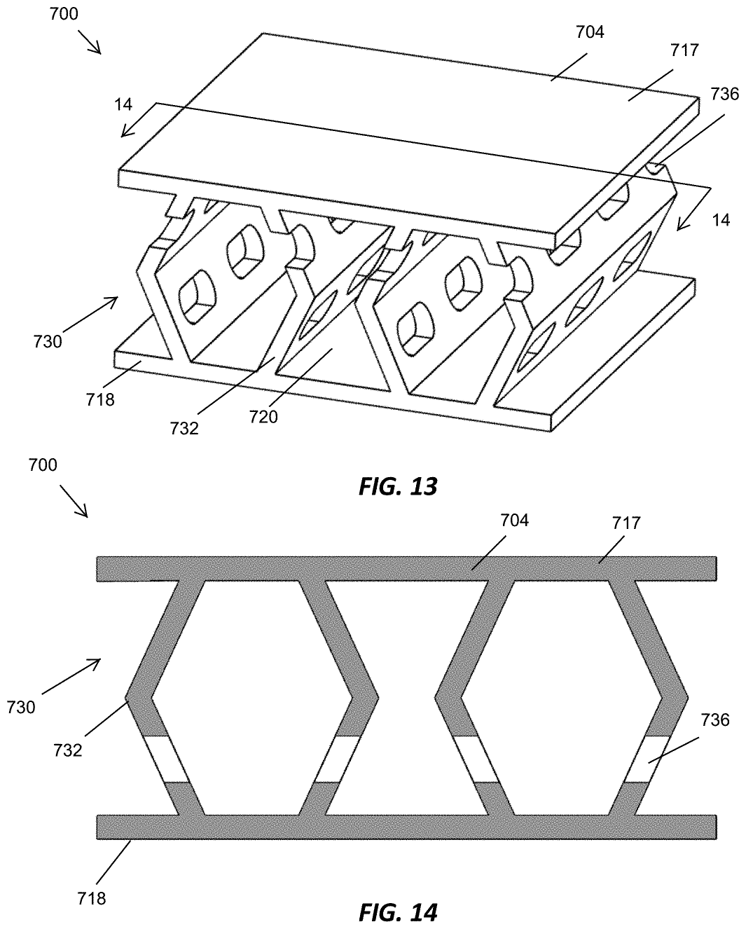

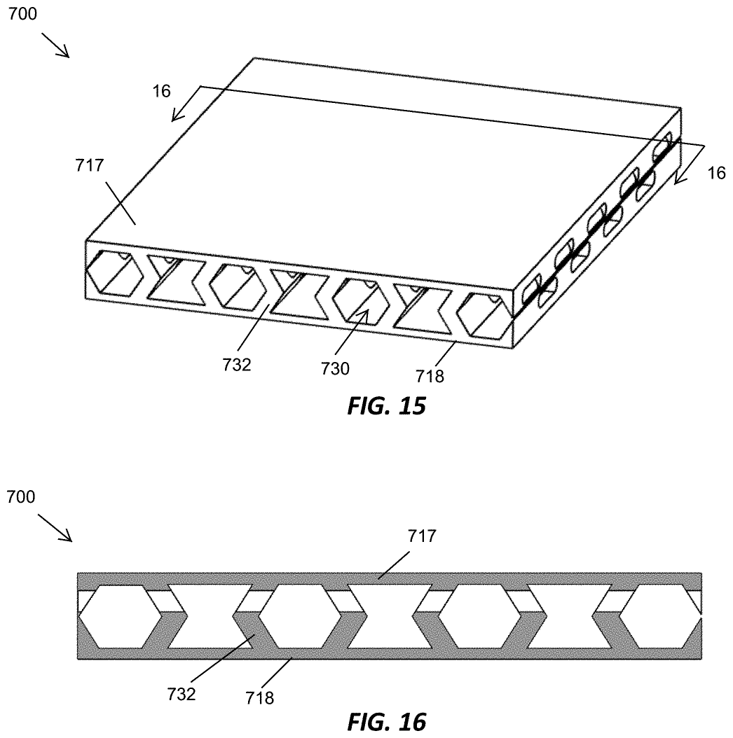

FIGS. 13-16 illustrate a steel slab 700 according to another embodiment of the present invention. The steel slab in FIGS. 13 and 14 is substantially similar to the steel slab in FIGS. 15 and 16 except the steel slab in FIGS. 13 and 14 is thicker. As such, the steel slabs will be described together.

The steel slab 700 includes a body 704 having pores 720 which form a truss structure of strut structure 730 between a first panel 717 and a second panel 718, similar to the steel slab 200 of FIG. 2. However, the steel slab 700 includes struts 732 having a cross-section that is hexagonal in shape. Each strut 732 in the illustrated embodiment is a linear element having a bend such that one strut 732 forms two sides of the hexagon. In other embodiments, some or all of the struts 732 can have other shapes connecting the first and second panels 717, 718, such as curved, stepped, and/or tapered struts. Two struts form one hexagon, with the first panel 717 and the second panel 718 forming two sides of the hexagonal. In other words, the pores 720 are hexagonal in shape. In the depicted embodiment, the steel slab 700 includes four struts 732 forming two hexagons. In other embodiments, the steel slab 700 may include any number of struts 732. The struts 732 are distributed consistently and repeatedly along a length of the first panel 717 such that the truss structure 730 is uniform throughout the steel slab 700. In other words, the struts 732 are arranged in a consistent pattern. In other embodiments, the truss structure 730 may be irregular throughout the steel slab 700. Each strut 732 extends a length of the steel slab 700 (i.e., from a first end of the first and second panels 717, 718 to a second end of the first and second panels 717, 718). In some embodiments, the struts 732 may only extend a portion of the length of the steel slab 700. In such embodiments, the other portion of the steel slab 700 may be solid or have different struts.

In the depicted embodiment, a thickness of each of the struts 732 is equal to or less than a thickness of the first and second panels 717, 718. In other embodiments, a thickness of each of the struts 732 may be greater than the thickness of the first and second panels 717, 718 (as shown in FIGS. 15 and 16). Each panel 717, 718 may have a thickness of at least 0.25 inches. In other embodiments, each panel 517, 518 may have a thickness of 0.5 inches or less. In some embodiments, the panels 517, 518 may have different thicknesses relative to each other. The steel slab 500 may have an overall thickness of at least 1 inch. In some embodiments, the steel slab 500 may have an overall thickness of at least 3 inches. In some embodiments, the steel slab 500 may have an overall thickness of at least 6 inches. In other embodiments, the steel slab 500 may have an overall thickness between 1 and 3 inches. In still other embodiments, the steel slab 500 may have an overall thickness between 1 and 6 inches.

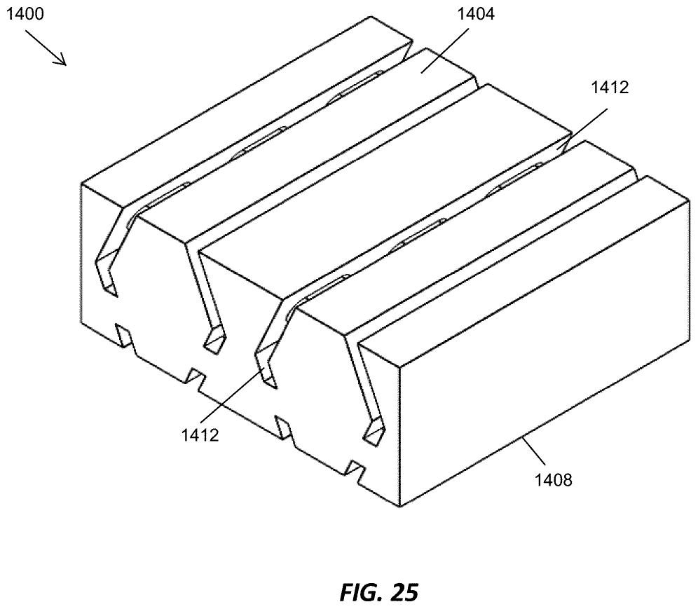

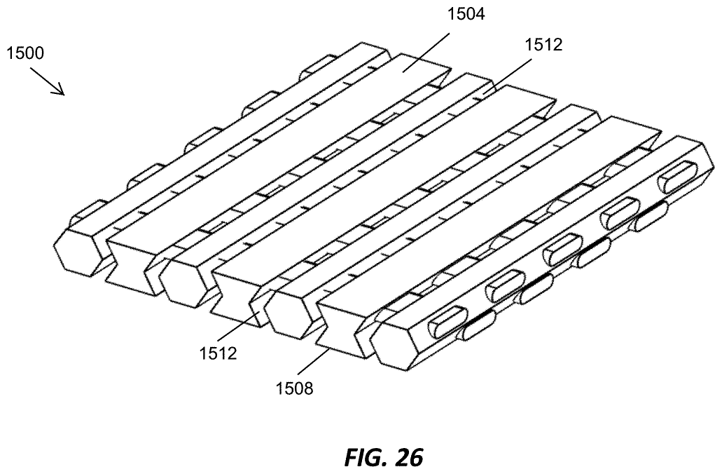

The struts 732 additionally include voids 736. The illustrated voids 736 are positioned at evenly spaced rows and columns along the struts 732 such that the voids 736 are uniform throughout the steel slab 700. The voids 736 allow material from, for example, a 3D printed insert (e.g., insert 1400 or 1500 in FIGS. 25 and 26) to be interconnected during casting. In the depicted embodiment, the voids 736 are oval in shape. In other embodiments, the voids 736 may have other shapes (e.g., circular, square, hexagonal, etc.). In still other embodiments, the voids 736 may not be present on every or any of the struts 732.

The truss structure 730 of the steel sheet 700 shown in FIGS. 13-16 is integrally formed with the first panel 717 and the second panel 718. In other embodiments, the truss structure 730 may be formed as a separate piece from one or both of the panels 717, 718. In such embodiments, the truss structure 730 may be secured (e.g., welded) to one of both of the panels 717, 718.

The truss structure 730 forms an auxetic structure between the first panel 717 and the second panel 718. Auxetic structures have a negative Poisson's ratio. When the auxetic structure is stretched, the structure becomes thicker perpendicular to an applied force. This occurs due to the shape of the auxetic structure deforming when a force is imparted onto the auxetic structure. For example, the octagonal shape of the truss structure 730 allows the truss structure 730 to extend when a blast forces the first and second panels 717, 718 apart. This extension of the truss structure 730 allows the truss structure 730 to absorb energy imparted onto the steel sheet 700 by the blast. The absorption of energy provides the steel sheet 700 greater blast resistance than a conventional, solid steel sheet.

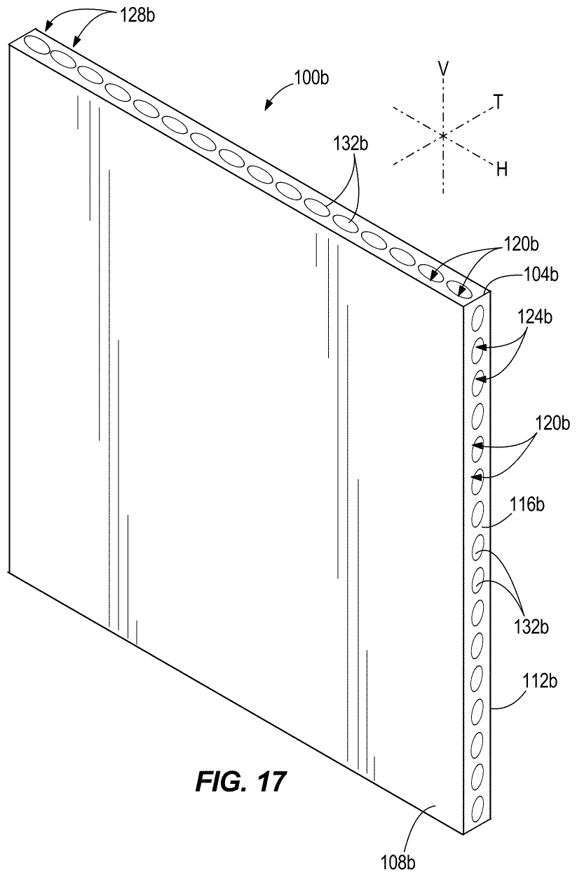

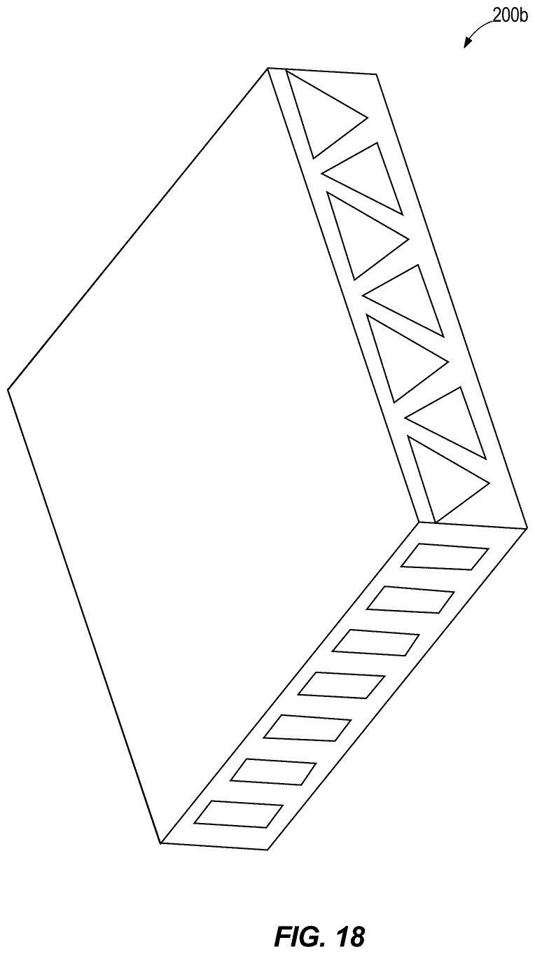

FIG. 17 illustrates a hot-rolled steel sheet 100b according to an embodiment of the present invention. The hot-rolled steel sheet 100b is the steel slab 100 shown in FIG. 1 after the steel slab 100 has undergone a hot rolling process as disclosed herein. The steel sheet 100b has the same chemical composition as described above in relation to the steel slab 100. The steel sheet 100b includes a steel body 104b that is similar in shape to the steel body 104, but has been flattened. When compared with the first face 108 and the second face 112 of the steel slab 100, a first face 108b and a second face 112b of the steel sheet 100b have greater surface areas. A thickness of a peripheral edge 116b (i.e., a distance between the first face 108b and the second face 112b) of the steel sheet 100b is less than a thickness of the peripheral edge 116 of the steel slab 100. In some embodiments, the thickness of the peripheral edge 116b may be reduced between 25% and 75% relative to the thickness of the peripheral edge 116. In some embodiments, the thickness of the peripheral edge 116b may be reduced at least 25%. In other embodiments, the thickness of the peripheral edge 116b may be reduced at least 50%. In yet other embodiments, the thickness of the peripheral edge 116b may be reduced at least 75%. In some embodiments, the thickness of the peripheral edge 116b may be reduced less than 75%. In further embodiments, the thickness may be reduced 20%, 25%, 30%, 35%, 40%, 45%, 50%, 55%, 60%, 65%, 70%, or 75%. The illustrated peripheral edge 116b has a thickness within a range of 0.25 inches to 0.75 inches. However, in some embodiments, the thickness may be less than 0.25 inches or greater than 0.75 inches.

The steel body 104b also includes a plurality of interconnected pores 120b forming a substantially uniform pattern within the body 104b. In some embodiments, the pores 120b have generally the same shape and configuration as the pores 120 described above in connection with FIG. 1, but are flattened during the hot rolling process. The pores 120b may also still be interconnected as also described above in connection with FIG. 1. In some embodiments, some of the pores 120b may no longer be interconnected due to the flattening process. In other embodiments, all or substantially all of the pores 120b may no longer be interconnected (e.g., each of the pores 120b may be isolated from adjacent pores 120b) due to the flattening process that collapses the channels between adjacent pores 120b. After hot rolling, at least some of the plurality of interconnected pores 120b have substantially oval shaped cross-sections. In other embodiments, the pores 120b may have other flattened shapes (e.g., flattened oblong shapes, football-shaped, flattened cubic shapes, flattened polygonal shapes, etc.), depending at least in part upon the starting shapes of the pores 120. Further, some of the pores 120b may be flattened to different degrees relative to other pores 120b. By way of example only, pores 120b closer to a center of the body 104b may be more flattened than pores 120b closer to the peripheral edge 116b of the body 104b, or vice versa.

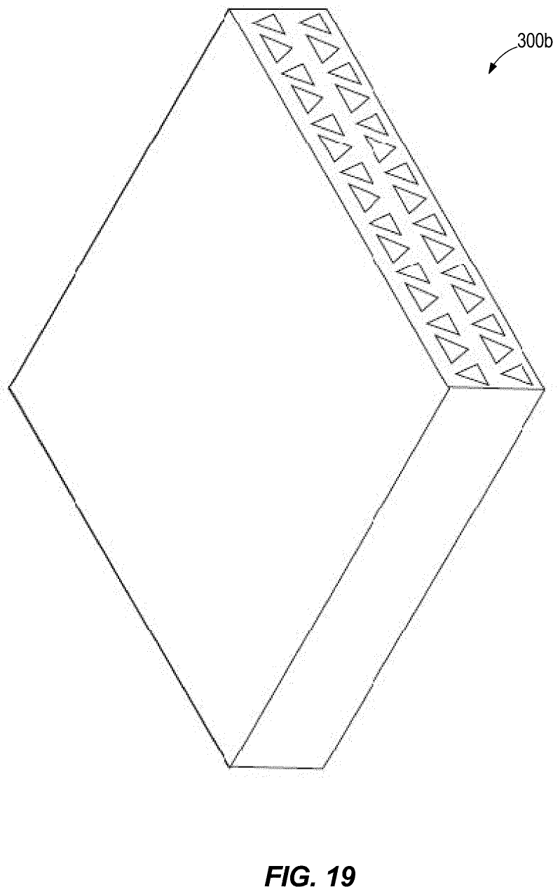

The steel slabs of FIGS. 1-6 may be, but do not necessarily need to be, hot rolled into hot-rolled steel sheets 100b, 200b, 300b of FIGS. 17-19. FIGS. 7-16 may also be, but do not necessarily need to be, hot rolled into hot-rolled steel sheets. The pores of the hot-rolled steel sheets 100b, 200b, 300b, can include generally the same shapes as the pores 120, 220, 320 described above, but with flattened profiles (resulting from the hot rolling process) when viewed in a cross-sectional plane oriented perpendicularly with respect to the opposite exterior surfaces of the sheet 100b, 200b, 300b. Accordingly, the hot-rolled steel sheets 100b, 200b, 300b can have a plurality of flattened interconnected pores forming a substantially uniform pattern within the sheets 100b, 200b, 300b. Like the steel slabs from which the steel sheets 100b, 200b, 300b are formed, the substantially uniform pattern can be a generally two-dimensional pattern (a grid, array, or lattice, by way of example only) that can define a rectangular pattern within the body of the steel sheets 100b, 200b, 300b. In other embodiments, the substantially uniform pattern can be a three-dimensional pattern that can also define a rectangular or prismatic pattern within the body of the steel sheets 100b, 200b, 300b. In other embodiments, the two-dimensional or three-dimensional arrangement of pores do not define an identifiable pattern as just described, yet still define a network of interconnected pores within the steel sheets 100b, 200b, 300b.

As described above, the pores 120, 220, 320 can become flattened (i.e., having a flattened profile) from the hot rolling process also described herein. As a result, the pores 120, 200, 320 can each take on a shape in which each pore has length and/or width dimensions (in the plane of the steel sheet 100b, 200b, 300b) that are larger than the thickness dimensions (in a direction that is perpendicular to the steel sheet 100b, 200b, 300b). In some embodiments, at least a majority of the pores in the steel sheet 100b, 200b, 300b have this shape and orientation. Also in some embodiments, at least 80% of the pores in the steel sheet 100b, 200b, 300b have this shape and orientation.

Also as a result of the hot rolling process, the pores 120, 200, 320 can each take on a shape in which each pore has length (i.e., largest dimension) oriented generally in a common direction. In some embodiments, the common direction is the direction in which the steel slab 100, 200, 300, 400, 500, 600, 700, 400, 500, 600, 700 was rolled, or in the length (i.e., largest dimension) direction of the steel slab and steel sheets 100b, 200b, 300b. In some embodiments, at least a majority of the pores in the steel sheet 100b, 200b, 300b have this orientation. Also in some embodiments, at least 80% of the pores in the steel sheet 100b, 200b, 300b have this shape and orientation.

The pores in the resulting steel sheets 100b, 200b, 300b can still have the same general shape and/or relative arrangement as that in the steel slabs 100, 200, 300, 400, 500, 600, 700, 400, 500, 600, 700 from which the steel sheets 100b, 200b, 300b were formed, albeit with a generally flattened profile as described above. Accordingly, pores 120 having different shapes interconnected as described above can still have different shapes and interconnections. Similarly, pores 120, 220, 320 having two or more different pore sizes within the steel slabs 100, 200, 300, 400, 500, 600, 700, 400, 500, 600, 700 can still have two more different flattened pore sizes within the steel sheets 100b, 200b, 300b.

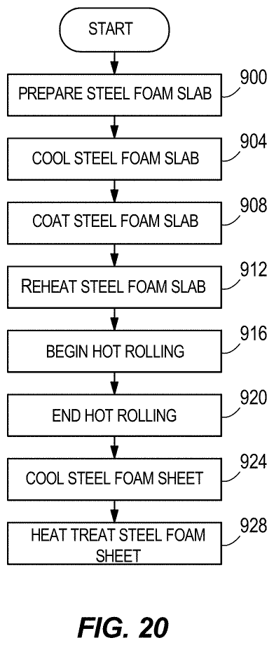

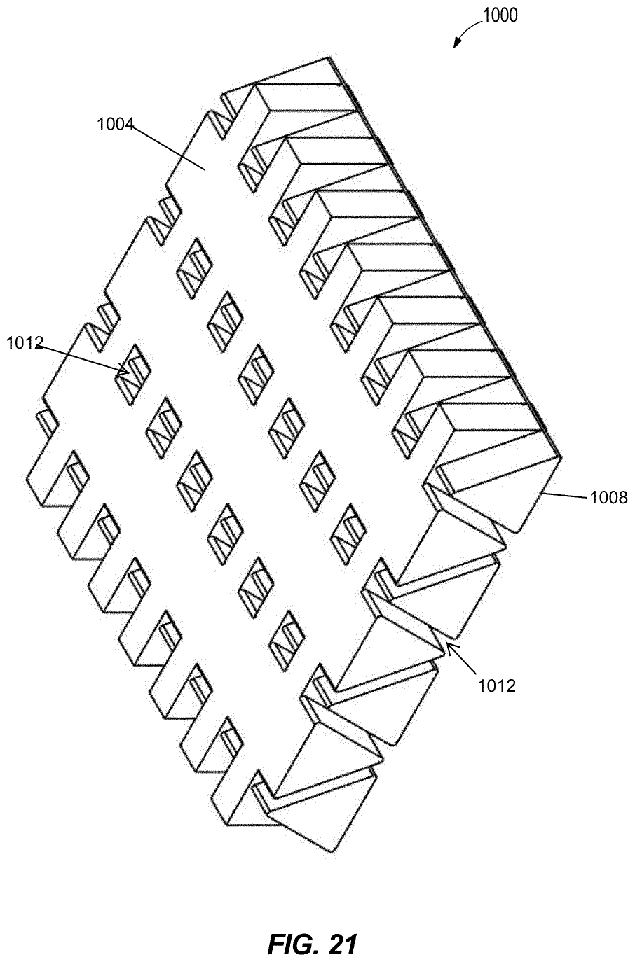

FIG. 20 is a flowchart depicting a method of hot rolling a steel slab. References below to the steel slab generally refer to the steel slabs from FIGS. 1-6. References below to the steel sheet generally refer to the hot-rolled steel sheets from FIGS. 17-19, which depicts the steel slabs 100, 200, 300 after the steel slabs 100, 200, 300 have been hot-rolled. The slabs 400, 500, 600, 700 after the steel slabs 400, 500, 600, 700, 400, 500, 600, 700 have been hot-rolled are not depicted. Although the method is described with reference to certain steps, not all of the steps need to be performed or need to be performed in the order presented. It will be appreciated that the method discussed below is equally applicable to lightweight steel slabs including other pore shapes, pore sizes, and pore arrangements as discussed herein.

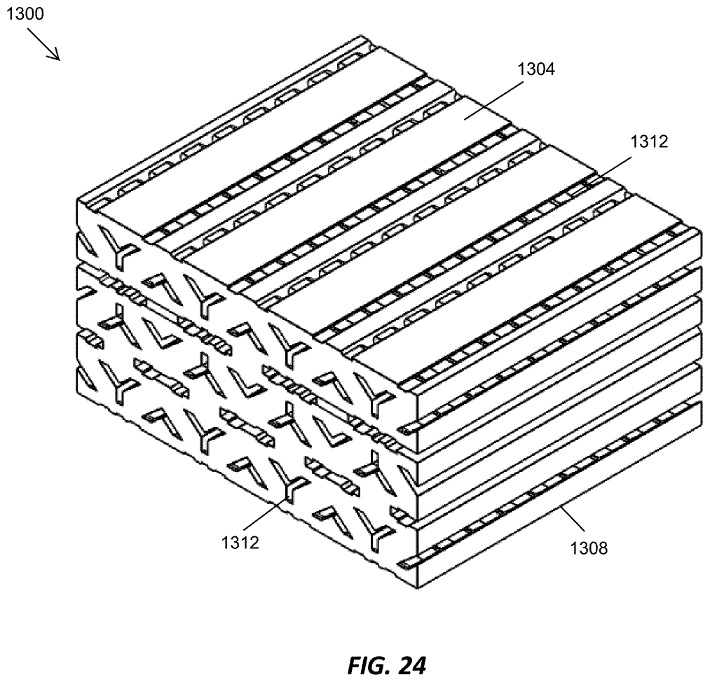

At Step 900, the steel slab 100, 200, 300, 400, 500, 600, 700, 400, 500, 600, 700 is prepared by, for example, sand casting molten steel. Possible methods of preparing the steel slab 100 are disclosed in U.S. Pat. Nos. 9,623,480 and 10,493,522, the entire contents of which are incorporated by reference herein. As described above, the steel slab 100 includes the plurality of interconnected pores 120 that can form a substantially uniform pattern within the steel slab 100. In some embodiment, the interconnected pores 120 are formed through the method of casting the molten steel into the steel slab 100. In some embodiments, the interconnected pores 120 are formed as a plurality of spheres and cylinders. To prepare the steel slab of FIG. 2, a similar method described in the '480 and '522 Patents is used with an insert 1000 shown in FIG. 21. To prepare the steel slab of FIG. 4, two of the inserts 1000 may be used to create the pore layers 350 between the panel layers 354. The inserts 1000 may be separated by, for example, one or more shims when positioned within a mold. In further embodiments, more than two inserts 1000 may be used to create a steel slab with more than two pore layers. To prepare the steel slab of FIG. 4, a similar method described in the '480 and '522 Patents is used with an insert 1100 shown in FIG. 22. To prepare the steel slab of FIG. 8, a similar method described in the '480 and '522 Patents is used with an insert 1200 shown in FIG. 23. To prepare the steel slab of FIG. 10, a similar method described in the '480 and '522 Patents is used with an insert 1300 shown in FIG. 24. To prepare the steel slab of FIG. 12, a similar method described in the '480 and '522 Patents is used with an insert 1400 shown in FIG. 25. To prepare the steel slab of FIG. 14, a similar method described in the '480 and '522 Patents is used with an insert 1500 shown in FIG. 26.

After the steel slab 100, 200, 300, 400, 500, 600, 700, 400, 500, 600, 700 has been prepared, the steel slab 100, 200, 300, 400, 500, 600, 700, 400, 500, 600, 700 is cooled (Step 904). In some embodiments, the steel slab 100, 200, 300, 400, 500, 600, 700, 400, 500, 600, 700 may be cooled to 600 degrees Celsius. The steel slab 100, 200, 300, 400, 500, 600, 700, 400, 500, 600, 700 is cooled within, for example, six hours of completing preparation of the steel slab 100, 200, 300, 400, 500, 600, 700, 400, 500, 600, 700. In other embodiments, the steel slab 100, 200, 300, 400, 500, 600, 700, 400, 500, 600, 700 may be cooled to other suitable temperatures, or within other time periods.

After the steel slab 100, 200, 300, 400, 500, 600, 700, 400, 500, 600, 700 has been cooled in the illustrated embodiment, an antiscale coating is applied to the steel slab 100, 200, 300, 400, 500, 600, 700, 400, 500, 600, 700 (Step 908). The antiscale coating may be applied to interior and exterior surfaces of the steel slab 100, 200, 300, 400, 500, 600, 700, 400, 500, 600, 700 to reduce or minimize scaling of the interconnected pores 120 (Step 908). In some embodiments, this step may be omitted.

With continued reference to the illustrated embodiment of FIG. 20, following applying the antiscale coating, the steel slab 100, 200, 300, 400, 500, 600, 700, 400, 500, 600, 700 is reheated (Step 912). In some embodiments, the steel slab 100, 200, 300, 400, 500, 600, 700, 400, 500, 600, 700 may be reheated to a temperature of 1050 to 1230 degrees Celsius. In other embodiments, the steel slab 100, 200, 300, 400, 500, 600, 700, 400, 500, 600, 700 may be reheated to other suitable temperatures. Reheating may occur in, for example, a soaking oven. The steel slab 100, 200, 300, 400, 500, 600, 700, 400, 500, 600, 700 can be soaked in the soaking oven for a time of 1.5 hours per inch of thickness of the slab. For example, in some embodiments, the steel slab 100, 200, 300, 400, 500, 600, 700, 400, 500, 600, 700 has a thickness of 1 inch to 2 inches, which corresponds to a soaking time of 1.5 hours to 3 hours. The soaking oven may be a gas-fired or oil-fired soaking oven. In additional embodiments, the steel slab 100, 200, 300, 400, 500, 600, 700, 400, 500, 600, 700 may be heated through induction heating, or in other suitable manners.

At Step 916, the reheated steel slab 100, 200, 300, 400, 500, 600, 700, 400, 500, 600, 700 begins a hot rolling cycle. The starting temperature of the steel slab 100, 200, 300, 400, 500, 600, 700, 400, 500, 600, 700 as it begins the hot rolling cycle may be between 1050 degrees Celsius and 1230 degrees Celsius. In some embodiments, the hot rolling cycle begins by passing the steel slab 100, 200, 300, 400, 500, 600, 700, 400, 500, 600, 700 between a first roller and a second roller of a mill. The first roller and the second roller can rotate in opposing directions, thereby moving the steel slab 100, 200, 300, 400, 500, 600, 700, 400, 500, 600, 700 through the rollers. The steel slab 100, 200, 300, 400, 500, 600, 700, 400, 500, 600, 700 can be passed through the first roller and the second roller in a range of two to six passes, or may be passed through multiple sets of rollers, forming the steel sheet 100b. The number of passes the steel slab 100, 200, 300, 400, 500, 600, 700 undergoes can correspond to a reduction of thickness of the steel slab 100, 200, 300, 400, 500, 600, 700 of between 25% and 75%. In some embodiments, the steel slab 100, 200, 300, 400, 500, 600, 700 starts the hot rolling cycle at a thickness in a range of 1 inch to 2 inches, and the steel sheet 100b finishes hot rolling at a thickness in a range of 0.25 of an inch to 0.75 of an inch. In other embodiments, the steel slab 100, 200, 300, 400, 500, 600, 700 may have other starting thicknesses, and/or the steel sheet 100b, 200b, 300b may have other finishing thicknesses.

Through the process of hot rolling, in some embodiments the interconnected pores 120 are flattened. In the illustrated embodiment of FIG. 1, the pores 120 are flattened such that at least some of the plurality of pores 120b have substantially oval-shaped cross-sections. In some embodiments, each of the plurality of pores 120b will have substantially similar oval-shaped cross-sections, while the plurality of pores in additional embodiments may include cross-sections that vary in size and shape. In the illustrated embodiments of FIGS. 2 and 4, the pores 220, 320 are flattened such that at least some of the plurality of pores have flattened triangular-shaped cross-sections.

At Step 920, the hot rolling process ends. In some embodiments, a final temperature of the steel sheet 100b, 200b, 300c as the steel sheet completes hot rolling is greater than or equal to 850 degrees Celsius. In the event that the steel sheet 100b, 200b, 300b reaches the final temperature prior to a desired thickness being reached, the steel sheet 100b, 200b, 300c can again be soaked in a soaking oven to increase the temperature of the steel sheet 100b, 200b, 300b. Once the temperature of the steel sheet 100b, 200b, 300b has increased, the hot rolling cycle may continue.

At Step 924, the steel sheet 100b, 200b, 300b is cooled. In some embodiments, cooling of the steel sheet 100b, 200b, 300b may begin within five seconds of completion of hot rolling. The cooling of the steel sheet 100b, 200b, 300b may be an uncontrolled cooling process, meaning the steel sheet 100b, 200b, 300b does not undergo further treatment to facilitate cooling. In other embodiments, the cooling process may be controlled. In one example, the steel sheet 100b, 200b, 300b is initially cooled at a cooling rate in the range of 2 degrees Celsius per minute to 10 degrees Celsius per minute until the steel sheet 100b, 200b, 300b reaches an ambient temperature of approximately 30 degrees Celsius.

At Step 928 of the illustrated embodiment, the steel sheet 100b, 200b, 300b is heat treated. In some embodiments, the steel sheet 100b, 200b, 300b may be heat treated through a quenching and tempering process. In other embodiments, the steel sheet 100b, 200b, 300b may be heat treated through a normalizing and tempering process. The steel sheet 100b, 200b, 300b can be heat treated to achieve a hardness in a range of, for example, 150 Brinell hardness number (BHN) to 400 BHN. In some embodiments, the steel sheet 100b, 200b, 300b may be heat treated to have a hardness of 150 BHN, 200 BHN, 250 BHN, 300 BHN, 350 BHN, or 400 BHN. In other embodiments, the steel sheet 100b may be heat treated to have a hardness less than 150 BHN or greater than 400 BHN. In further embodiments, this step may be omitted.

As noted above, FIG. 21 illustrates the insert 1000 used for forming the strut structure 230 of the steel slabs 200, 300 shown in FIGS. 2-6. The illustrated insert 1000 includes two faces 1004, 1008 and a series of channels 1012 extending between the faces 1004, 1008. The channels 1012 are voids of space matching the shapes of the struts 232 (FIG. 2). As such, the channels 1012 may be formed to have different configurations (e.g., angles, lengths, thicknesses, etc.) depending on the desired configurations of the struts 232.

FIG. 22 illustrates an insert 1100 used for forming the strut structure 430 of the steel slabs 400 shown in FIGS. 7 and 8. The illustrated insert 1100 includes two faces 1104, 1108 and a series of channels 1112 extending between the faces 1104, 1108. The channels 1112 are voids of space matching the shapes of the struts 432 (FIG. 8). As such, the channels 1112 may be formed to have different configurations (e.g., angles, lengths, thicknesses, etc.) depending on the desired configurations of the struts 432.

FIG. 23 illustrates an insert 1200 used for forming the strut structure 530 of the steel slabs 500 shown in FIGS. 9 and 10. The illustrated insert 1200 includes two faces 1204, 1208 and a series of channels 1212 extending between the faces 1204, 1208. The channels 1212 are voids of space matching the shapes of the struts 532 (FIG. 10). As such, the channels 1212 may be formed to have different configurations (e.g., angles, lengths, thicknesses, etc.) depending on the desired configurations of the struts 532.

FIG. 24 illustrates an insert 1300 used for forming the strut structure 630 of the steel slabs 600 shown in FIGS. 11 and 12. The illustrated insert 1300 includes two faces 1304, 1308 and a series of channels 1312 extending between the faces 1304, 1308. The channels 1312 are voids of space matching the shapes of the struts 632 (FIG. 12). As such, the channels 1312 may be formed to have different configurations (e.g., angles, lengths, thicknesses, etc.) depending on the desired configurations of the struts 632.

FIG. 25 illustrates an insert 1400 used for forming the strut structure 730 of the steel slabs 700 shown in FIGS. 13 and 14. The illustrated insert 1400 includes two faces 1404, 1408 and a series of channels 1412 extending between the faces 1404, 1408. The channels 1412 are voids of space matching the shapes of the struts 732 (FIG. 14). As such, the channels 1412 may be formed to have different configurations (e.g., angles, lengths, thicknesses, etc.) depending on the desired configurations of the struts 732.

FIG. 26 illustrates an insert 1500 used for forming the strut structure 730 of the steel slabs 700 shown in FIGS. 15 and 16. The illustrated insert 1500 includes two faces 1504, 1508 and a series of channels 1512 extending between the faces 1504, 1508. The channels 1512 are voids of space matching the shapes of the struts 732 (FIG. 16). As such, the channels 1512 may be formed to have different configurations (e.g., angles, lengths, thicknesses, etc.) depending on the desired configurations of the struts 732.

The insert 1000, 1100, 1200, 1300, 1400, 1500 can be used in a sand casting process, such as the process disclosed in U.S. Pat. Nos. 9,623,480 and 10,493,522. As such, the insert 1000, 1100, 1200, 1300, 1400, 1500 may formed using similar materials and processes disclosed in the '480 and '522 Patents, such as 3-D printing.

The above techniques allow for the creation of steel sheets or composite panels, with ballistic-resistant application for, for example, military structures (e.g., ballistic plates), civilian structures (e.g., building and bridges), naval applications, and the like. In some scenarios, the steel sheets may be used in ships or aircrafts. The steel sheets or composite panels also have applications in energy absorption, blast resistance, and sound absorption. The lightweight steel slabs used to cast the steel sheets allow for large steel sheets to be produced cost-effectively, as larger thickness sections of the steel slabs may be used. Structural advantages of lightweight steel sheets compared to solid steel sheets include minimization of weight, maximization of flexural strength, increased energy dissipation, and increased damping.

Non-auxetic structures (such as the steel slabs shown in FIGS. 2-12) are very good for ballistic resistance by having more material (e.g., plates) in the line of a shot when a bullet or other projectile hits. Controlling the chemistry and heat treatment to give higher hardness gives higher ballistic resistance. In contrast, auxetic structures (such as the steel slabs shown in FIGS. 13-16) are found to have higher blast resistance due to their negative Poisson's ratio and ability to collapse under the influence of blast pressure. Lower hardness tends to favor blast resistance, while higher hardness tends to favor ballistic resistance. Controlling the chemistry and heat treatment allows production of both ballistic resistant and blast resistant lightweight steel sheets with areal densities comparable to similar thickness aluminum plates.

Although the steel slabs 100, 200, 300, 400, 500, 600, 700, 400, 500, 600, 700 are all described above as going through a hot-rolling process, in some scenarios, the steel slabs 100, 200, 300, 400, 500, 600, 700, 400, 500, 600, 700 may be used as-is without hot-rolling. If the steel slabs are not hot rolled, the steel slabs can still be used as steel sheets or as other components. For example, some applications may require a combination of panels that are both hot-rolled and not hot-rolled. Alternatively, some applications may only require panels that are not hot-rolled.

Various features and advantages of the invention are set forth in the following claims.

What is claimed is:

1. A lightweight steel slab comprising:
a first panel defining a first plane;
a second panel spaced apart from the first panel and defining a second plane; and
a truss structure coupled to the first panel and the second panel, the truss structure including a plurality of struts extending between the first panel and the second panel, at least some of the plurality of struts including linear elements that are obliquely angled relative to the first plane and the second plane.

2. The lightweight steel slab of claim 1, wherein at least some of the plurality of struts are linear elements that are perpendicular relative to the first plane and the second plane.

3. The lightweight steel slab of claim 1, wherein the truss structure is uniform throughout the lightweight steel slab.

4. The lightweight steel slab of claim 1, wherein the truss structure is non-auxetic.

5. The lightweight steel slab of claim 4, wherein the at least some of the plurality of struts form Y-shaped trusses, V-shaped trusses, or both.

6. The lightweight steel slab of claim 5, wherein the truss structure alternates between the Y-shaped trusses and the V-shaped trusses.

7. The lightweight steel slab of claim 5, wherein the Y-shaped trusses are coupled to both the first panel and the second panel, and wherein each V-shaped truss is only coupled to one of the first panel or the second panel.

8. The lightweight steel slab of claim 1, wherein the truss structure is auxetic.

9. The lightweight steel slab of claim 8, wherein the at least some of the plurality of struts include bent linear elements.

10. The lightweight steel slab of claim 1, wherein the truss structure includes multiple levels of struts between the first panel and the second panel.

11. The lightweight steel slab of claim 1, wherein the truss structure includes voids formed in the plurality of struts.

12. The lightweight steel slab of claim 11, wherein the voids are uniformly distributed in the plurality of struts.

13. The lightweight steel slab of claim 1, wherein the first panel, the second panel, and the truss structure are integrally formed as a single piece.

14. The lightweight steel slab of claim 1, wherein each strut of the truss structure is coupled with both the first panel and the second panel.

15. The lightweight steel slab of claim 1, wherein the first panel includes a first end and a second end, and wherein each strut extends from the first end to the second end.

16. A lightweight steel slab comprising:
a first panel having a first end, a second end, and a length extending between the first end and the second end;
a second panel spaced apart from the first panel; and
a truss structure integrally formed as a single piece with the first panel and the second panel, the truss structure including a plurality of struts extending between the first panel and the second panel, the plurality of struts being distributed consistently and repeatedly along the length of the first panel.

17. The lightweight steel slab of claim 16, wherein the truss structure is non-auxetic.

18. The lightweight steel slab of claim 16, wherein the truss structure is auxetic.

19. A lightweight steel slab comprising:
a first panel;
a second panel spaced apart from the first panel; and
an auxetic truss structure coupled to the first panel and the second panel, the auxetic truss structure including a plurality of struts extending between the first panel and the second panel.

20. The lightweight steel slab of claim 19, wherein the auxetic truss structure is integrally formed as a single piece with the first panel and the second panel.
